(19) United States
(12) Patent Application Publication
(10) Pub. No.: US 2006/0198501 A1
(43) Pub. Date: Sep. 7, 2006

(54) Method and device for constructing a voice dialog

(75) Inventor: Mikael Marche, Lannion (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/370,076

(22) Filed: Mar. 7, 2006

(30) Foreign Application Priority Data
Mar. 7, 2005 (FR) 0502256

(51) Int. Cl. H04M 1/64

(52) U.S. Cl. 379/88.17

(57) ABSTRACT

A method of constructing a voice dialog comprising the steps of (i) defining a plurality of sub-dialogs in a determined voice dialog; (ii) determining chaining sequences between at least some of the sub-dialogs; and (iii) producing a specification of the voice dialog by transforming at least the sub-dialogs and chaining sequences into elements of a low-level formal model.

### BACKGROUND OF THE INVENTION

The present invention relates to the field of dialogs for voice applications, called voice dialogs. Such a voice application, is for example, a service rendered to the user of a telephone terminal in which the service communicates with the user by broadcasting voice messages that are pre-recorded or produced by voice synthesis. The user communicates with the aid of the terminal keys, for example, the dual tone multifrequency (“DTMF”) keys and/or by means of voice commands comprising keywords recognized by a voice recognition engine. All the possible interactions between the user and the application form the voice dialog, which is itself frequently broken down into sub-dialogs (the conventional sub-dialogs include the number entry sub-dialog, the greeting sub-dialog, etc.).

The construction of a voice application usually includes the production of a functional specification of the voice dialog. The specification describes, on the one hand, the chaining sequences of the user/service interactions (the dialog logic), and on the other hand, the elements handled during these interactions: trigger events such as the significant keywords in the dialog, voice messages broadcast by the application, handled data, and invocations of external services (for example, connection to an information system).

Today, particularly with the arrival of new standards such as VoiceXML, voice dialogs are becoming increasingly complex, which generates an increase in the need to validate these dialogs.

There exist today several voice service construction tools, for example, Audium Builder from Audium Corporation, VoiceObjects Factory, Microsoft Speech Application Software Development Kit (“SASDK”) and Voice Toolkit 5.0 from IBM.

These tools have the disadvantage that the technique employed for the specification and the one adopted for the implementation are not independent. They are, in fact, complete development chains, going from the software design workbench up to the final service execution platform.

For example, the VoiceObjects Factory workbench is totally dependent on the VoiceObjects Server execution engine. SASDK validates the behavior of the application before its deployment through a debug mode which works directly on the application code; the study of the behavior, therefore, depends on the implementation of the system.

It is desirable that certain validation steps, particularly the validation of the functional specification at least, can be observed independently of the technical implementation solutions finally adopted to offer these functionalities.

Specifically, since telecommunication services are systems with a fairly long life cycle, a specification should ideally be a generic source of study, independent of the implementations, so that the validations and tests obtained from the specification are applicable to several implementations of the specification.

The CRESS approach, from Bellcore, is also used in the prior art. It proposes a transformation of the initial specification into a formal modeling language such as SDL or LOTOS, to apply proven analysis techniques to these formalisms.

The CRESS approach, however, remains very dependent on the capabilities of the proposed formalism. The CHISEL formalism for example, initially designed to describe telecommunication systems, does not allow the description of functionalities specific to voice dialogs (for example, dialog creation; that is, the expression of behaviors whose existence is dynamic over time).

### SUMMARY OF THE INVENTION

The present invention aims to propose a solution for constructing a voice dialog so that a validation step may be applied independently of the technology used for the final implementation of the voice dialog.

As a result, according to a first aspect, the invention proposes a method of constructing a voice dialog comprising the following steps:
a plurality of sub-dialogs is defined in the voice dialog;
chaining sequences are determined between at least some of said sub-dialogs; and
a specification of the voice dialog is produced by transforming at least said sub-dialogs and chaining sequences into elements of a low-level formal model.

A formal model is a model entirely defined from proven mathematical theories (see “Introduction aux Methodes Formelles,” by J F Monin, Éditions Hermes, Collection Technique et Scientifique des Télécommunications), that is to say constructed according to a set of rules whose formalism varies according to the nature of the models (logic rules, structural rules, rewrite rules, deduction rules, etc.) and associating with an element of definition or action of a model an element corresponding to the mathematical theory.

The usual mathematical theories serving as bases for formal models are, for example, set theory, Hoare logic, theories of algebraic specifications, transition systems (or LTS, “Labeled Transition System”), and deduction systems theory.

The IF, pi-calculus, UNITY and CCS models are included in the formal models defined on the basis of mathematical transition systems theory.

On the other hand, the Unified Modeling Language (“UML”) is not a formal model, but a description formalism most of whose constructions have no mathematical foundation.

A low-level formal model is a formal model for which all the constructions are described directly by constructions of the mathematical formalism used as a basis. For example, IF is a low-level formal model based on transitions systems theory. Prolog is a low-level formal model based on deduction systems theory.

In contrast, a high-level formal model is a formal model whose basic constructions rely on mathematical theories but also proposes several high-level constructions founded by the association of basic constructions relating to different respective mathematical foundations. The rules of association are, for example, of the Heritage, Polymorphism, etc., types. SDL is an example of a high-level formal model.

The choice of a low-level model to represent the specification of a dialog makes it possible to obtain a canonical representation of the specification, independent of the choices finally made for the specification.

Based on such a specification, dialog validation steps can, therefore, be directly applied, for example, in simulation and/or conformity test steps that are not dependent on the implementation.

In one embodiment of the invention, the low-level formal model is an Input Output Labeled Transition System (“IOLTS”) model. This model is an extension of the LTS models in which three types of action can be observed: the inputs, the outputs, and the internal elements (states and transitions between states).

Such a model will make applying conformity tests easier.

The transitions will be activated following the transmittal or receipt of data during execution of the dialog.

A dialog usually includes, as indicated above, several sub-dialogs. A first sub-dialog may be defined so that, during its execution, it can call a second sub-dialog. At the end of the second sub-dialog, the execution of the first sub-dialog may for example be continued or, on the other hand, be stopped. These behaviors are translated by interleaving rules (or chaining sequences) between sub-dialogs, which comprise call, continuation, and termination rules relating to these sub-dialogs.

Advantageously, the chaining sequences according to at least one set of rules from the call rules, continuation rules, and the termination rules relating to sub-dialogs are defined as a function of IOLTS model transitions and of activation of these transitions. This arrangement helps to specify a voice dialog execution logic.

In one embodiment of the method, in the case where the chosen model is such that the specification describes transitions between states, an algorithmic process of animating the specification is applied, comprising successive steps of activation and deactivation of transitions of the specification, to produce at least one validation step out of a step of simulating the dialog defined by the specification and a step of generating validation test cases designed to test an implementation of the dialog.

The simulation is a computing method that, at each step, describes the state of the simulated system, the states that can be accessed from this state, and the preceding states.

The dialog simulation step according to the invention is carried out based on the specification of the modeled dialog.

The fact that the specification is defined with the aid of a low-level formal model and that the simulation is constructed from the specification will make it possible to verify the conformity of the specification with the requirements relating to the dialog that have served as the bases for writing the specifications, and this is so irrespective of any choice of implementation of the dialog.

Simulations however do not guarantee the verification of a dialog implementation relative to the dialog specification. To do this, the dialog validation step must also include the running of tests for conformity of the dialog implementation relative to the specification.

The running of a conformity test consists of executing on the implementation a test case defined either manually or with the aid of standard test generation tools. A test case is a program designed to run on a tester device interfaced at the time of testing with the implementation of the dialog and comprising instructions concerning actions performed by the tester with respect to the implementation and stored behaviors of the implementation as a result of these actions. A comparison is then made between these stored behaviors and the expected behaviors according to the specification, which produces verdicts on the conformity between the implementation and the specification.

The IOLTS model distinguishes the observed events that will correspond to the results provided by the implementation of the dialog when it is under test, and the inspected events, which will correspond to the data supplied as input (chosen by the tester) to the implementation under test.

Generating the test cases based on the specification as defined according to the invention ensures that the test cases are independent of the implementation chosen for the dialog.

Furthermore, the dialogs conventionally apply data input operations (telephone number, pin code, etc.) that may contain a very large number of combinations. The generation of behavior tests for such dialogs having a high combinatorial element is a difficult step to control.

Existing test generation tools are usually content to enumerate the system states one by one relative to the input data. This enumeration generates an explosion of the test cases generated.

Advantageously, the step of generating validation test cases comprises the modification of the specification obtained according to the invention by replacing a plurality of inputs (for example, all the inputs by pressing the DTMF keys) with a single abstracted input, the algorithmic process of animating the specification being applied to the specification thus modified.

Therefore, signals supplied as inputs, from the user or outside applications, are represented in the form of abstractions that combine all the occurrences to which a voice dialog reacts, for example, the DTMF inputs of a telephone keypad or messages produced by the service. The signal “town” may represent the abstraction of a dialog input corresponding to the mention of any town by the dialog user.

This abstraction operation makes it possible to reason in a finite domain relative to real inputs that are infinite in number.

According to a second aspect, the invention proposes a voice dialog construction device comprising means for applying a method according to the invention.

According to a third aspect, the invention proposes a computer program comprising instructions for applying a method according to the first aspect of the invention.

### BRIEF DESCRIPTION OF THE DRAWING

FIG. 1 represents a flowchart indicating steps of a method according to the invention.

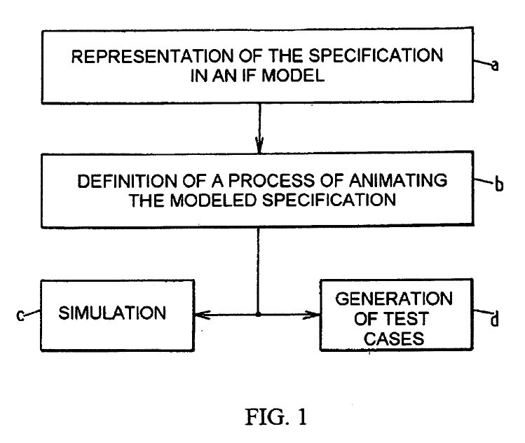

### DESCRIPTION OF PREFERRED EMBODIMENTS

An embodiment of the invention will now be described using a low-level formal model called IF, entirely defined on the basis of the IOLTS systems. For more information on this IF model, reference may be made to the information given at URL address http://www-verimag.imag.fr/DIST SYS/IF/ or in the document entitled “IF: An Intermediate Representation and Validation Environment for Timed Asynchronous Systems,” by M. Bozga, J. C. Fernandez, L. Ghirvu, S. Graf, J. P. Krimm, L. Mounier, In proceedings of FM'99 (Toulouse, France), September 1999.

The syntax elements of the IF model used according to the invention to describe the dialog models will be briefly presented first.

An IF system consists of a set of active objects defined on the basis of programmable logic controllers that run in parallel and communicate asynchronously through messages transported by communication channels. An IF system, therefore, consists of processes, communication channels, data, types, and signals.

Each of the IF processes is defined based on finite state machines identified by a Process Identifier (“PID”).

One instance of a process is the copy of a defined model of a process. The instantiation creates several processes based on one model, by giving them a name and without having to redefine the content thereof.

Each process instance has a FIFO receive queue for the incoming messages transported by the channels defined in the IF system attached to the process. The reaction of a process to the messages received is reflected in the transitions between states.

The description of an IF process includes the number of initial instances of the process, a list of formal parameters linked to the initialization of the process, a set of local variables representing the internal memory of the process, and a set of states/transitions defining the behavior of the process.

The concept of state is the main element in structuring the behavior of the IF process. At any time, a process is in one state and, following internal or external events, it may pass to another state of its behavior. The states have behavior characteristics that make it possible to define whether the current state is the initial state and if this state is stable or unstable. The initial state of a process is the state that is active when it is instantiated. The notion of stable or unstable state is linked to the atomicity of the transition sequences. Intuitively, an atomic transition between states is defined between two stable states, but may include processing and decision sub-transitions between unstable states. Thus, the atomic pitch of execution of an IF process is the sequence of transitions between stable states. A process cannot be interrupted by other processes when it is in an unstable state. Finally, it is possible to associate with each state filtering actions on the channels of a process that slow down the consumption of a message for subsequent states by saving the messages.

In IF, the transitions define the reaction of a process in response to the stimuli. The stimuli of a transition may be grouped into two types:

the presence of an input signal in one of the process channels; and

the evaluation of a Boolean expression that conditions the activation of a transition.

The reactions associated with the stimuli define sets of individual actions composed in sequences based on instructions of conventional conditional processes of the “if < >, then < >, else < >” type and of the “while < >, < >” loop. A transition must define the target state of the transition or determine the termination of the process, which signifies the destruction of the executed instance. It is also possible to prioritize one transition relative to others that can be activated in the same state by associating a degree of priority with each transition.

Several local declarations of types, of constants or of procedures handled by the process may be added to the definition of a process.

Communication between processes is applied with the aid of signals and communication channels.

The signals (or messages) are objects transported asynchronously through the communication channels of the IF system and are used to describe the communication between the processes. The declaration of a signal comprises its name and the list of parameter types transported, respectively.

A communication channel defines communication paths between two processes. Like the processes, the communication channels may be multi-instance and dynamic. Each instance of a channel is named and identified by a PID. The declaration of a channel includes the number of initial instances of the channel, the source and the destination of the signals transported, and the list of signals transported.

The data handled comprise types, constants, variables and expressions.

In IF, there are five types of predefined bases: Boolean, integer, float, PID, and clock, and type construction mechanisms such as the enumeration, the definition of intervals, the tables, and the records. In addition, it is possible to define abstractions of type. This functionality is exploited in a particularly advantageous embodiment of the invention.

The constants are used to name values representative of a system, and are, therefore, generally used in the expressions. It is also possible to use the constants to program the configuration of a system, such as the number of instances of a process or the size of a table. In IF, there are two particular constants, self and nil, which represent the PID of an instance and a zero PID value, respectively.

The variables and the formal parameters are identified by a unique name and are typed. The variables may be global to the system or local to the processes.

The expressions are constructed on top of variables and constants based on standard operators on the types handled in IF. In addition, the operators ‘.’ and ‘[ ]’ are introduced that make it possible to access the fields of a record type and the elements of a table, respectively. There is also a conversion operator, which makes it possible to transform values of PID or enumerated types into integers, and vice versa.

According to the invention, the specification of a voice dialog is constructed with the aid of transition systems in the form of IF processes.

The principles of this construction are described below, with reference to the single FIGURE.

A dialog describes the logic of the interactions between a service and its user for the purpose of fulfilling an objective. In particular, each functionality of the dialog is associated with a sub-dialog that allows the user to accomplish the objective of the functionality.

A dialog consists of sub-dialogs and is organized based on a specific sub-dialog (the main dialog), whose objective is to supply an overview of the service by providing access to the various functionalities of the services represented by sub-dialogs and that puts the execution of the sub-dialogs in order.

According to the invention, a dialog, like a sub-dialog, is represented as a sequence of states, the sequence being defined by means of transitions. Thus, the overall state of a dynamic service is defined by all the states of the active sub-dialogs.

Two instances of a sub-dialog with different contexts may cohabit at an instant T of the service.

Each sub-dialog sdi of a voice service according to the invention includes the main dialog, that is, initial dialog of the service, that is active at the beginning of any execution.

According to the invention, in a step a) of constructing an IF model of the specification, for each identified sub-dialog sdi, an IF process Psdi is constructed with the aid of the elements of IF syntax described above. The process Psdi may also declare elements indicated above:

a PID type parameter intended to make the link with a calling process for the sub-dialog sdi (that is, a process that, when executed, calls the sub-dialog sdi which then runs); this parameter is called the continuation parameter;

a Boolean type parameter designed to characterize the call of the sub-dialog: synchronous or asynchronous; this characterization is explained below;

a context-type parameter that encompasses the overall declarations of the service.

In addition, the voice service may also use everyday working objects of the information system such as a folder, a directory, a diary, etc.

In IF, and particularly in a formalism based on a transition system, this notion of an everyday working object has no direct representation. An object is represented according to the invention as the composition of a “data” portion and of several “operations” portions declared by the object, and each of these portions is converted into an IF process according to the following principle:

An IF process is created linked to the data of the object (the instance of this process represents the object itself). For each operation, a process is created that describes the dynamic behavior of the operation. The reference of the object in the IF system corresponds to the PID of the “data” process. The call to an object is translated by the dynamic creation of the corresponding “operation” process, with, as parameters, those defined for the “operation” process:

the PID of the “data” process; and

the PID of the calling process in order to return the execution result.

Finally, to allow the continuation of the call of an “operation” process, and the transfer of the results, each “operation” process sends to its calling process a return signal defined according to the translated method.

Furthermore, according to the invention, there are two types of sub-dialog states:

the stable states that represent waiting for an observable signal supplied by the user; and

the unstable states that represent markers in the dialog control stream (sequence of actions that cannot be controlled by the user).

A transition describes a possible move from one state to another. In practice, this is a control stream separating two states of a dialog.

From the outside, a user perceives only the “stable extremities” of the transitions, that is, the states in which the service pauses and hands over to him. Thus, between two user interventions, the service moves from one stable state to another stable node (the only ones that are perceptible from the outside), by passing through, where appropriate, several unstable states, in which cases several transitions are chained.

The service leaves a stable state by reacting to one of the observable signals awaited in that state, for example, an action on the part of the user (pressing a DTMF key or pronouncing a keyword). In the absence of such events, the service is suspended.

The invention makes it possible to define the interleaving of the various sub-dialogs of a dialog, defining the links between the calling sub-dialogs and the called sub-dialogs.

From a basic element of the transition systems which the activation of a transition between states is, it makes it possible to define sub-dialog call, continuation and termination rules.

These rules are created in an IF system by the definition of a controller process and by the addition of a continuation transition to all the processes modeling a sub-dialog. The role of the controller process is to activate the main dialog and stop the service (all the active sub-dialogs). The continuation transitions, based on the interchange of signals between processes, place the dialogs of the service in order.

Various interleaving streams are defined according to the invention: the blind asynchronous stream, the diversionary asynchronous stream, and termination synchronous stream.

A blind asynchronous stream defines the end of a sub-dialog, and the return of the hand to the calling sub-dialog.

The diversionary asynchronous stream is an interleaving that describes the end of the calling dialog, with an explicit transfer—forced—of the hand to the dialog designated in the asynchronous diversionary clause.

The calling sub-dialog does not recover the hand and is terminated, while the target sub-dialog of the diversion is activated. An asynchronous diversionary stream is a form of dialog invocation and, as such, can specify effective parameters.

The synchronous interleaving stream is an interleaving that defines a sub-dialog call so that the calling sub-dialog suspends its execution to give the hand to the called sub-dialog. When the called sub-dialog terminates, the calling sub-dialog resumes the hand and continues its execution.

This mode of invocation is, therefore, characterized by the fact that the calling dialog remains active during the execution of the sub-dialog (as opposed to the asynchronous stream).

To represent these streams of sub-dialog interleaving, the following signals are defined:

vt_next( ): the continuation signal sent by the processes that terminate their execution to an active process succeeding them;

vt_stop( ): sent by the process that decides on the termination of the service to the controller process; and

return_dialogeName(arg1, . . . , argN): the continuation signal sent by the process that terminates its execution, in a synchronous stream, to the process caller.

The blind asynchronous return more precisely describes the end of the active dialog process, and the hand-back to the last active parent dialog. To represent it in IF modeling, the “vt_next” signal is sent to the PID of the last active parent. Note that there is always at least one active process that is the dialog controller.

If the sub-dialog has itself been created by a synchronous stream type call, then the sub-dialog returns its continuation signal to its creator before sending the “vt_next” signal. The “vt_next” state must exist in all the IF processes representing a dialog.

A diversionary asynchronous stream is translated by the dynamic creation of the process defining the invoked dialog. As the calling dialog is destroyed during the call, the parameter for continuation of the calls made to the invoked dialog is the parent PID (the last active parent) known by the caller. By this mechanism, if the diverted dialog contains a “blind” return clause and a parent process no longer exists (which is the case only if the main dialog performs a diversion), then the last known caller is the controller of the service. Thus, on the one hand, the diversion semantic is not limited and, on the other hand, it is possible to raise an execution warning if the controller process receives the end of a diversion (dialog ending not explicitly provided by a termination).

If the sub-dialog that performs the diversion has been the subject of a synchronous stream type call, then the dialog returns to its creator its continuation signal (in the example: return_Dialog_Name), which may, where necessary, contain parameters.

The synchronous interleaving stream is translated according to the invention into IF according to the diversion principle, except that the caller is directed toward a wait state of the called dialog continuation signal followed by the vt_next signal that will be broadcast by the called dialog or one of these diversions.

The termination defines the interruption of the call by the service and, therefore; the end of all the active dialogs.

To translate this semantic into IF, all the processes of the system must be capable of killing themselves at any time. To produce this mechanism, the following are considered:

a termination signal “killall( )”;

transitions to the controller process whose role (among others) is to broadcast the killall( ) message, if it receives a stop message from any process;

a transition of reception of the killall( ) signal, which is added to all the states of a sub-dialog process that defines the wait for the end of a dialog (either by vt_next or by the procedure return signal); and

a “vt_stop( )” signal that is sent by the process that decides on the termination of the service to the controller process.

Therefore, the specification of a voice dialog may be represented according to the invention in an IF model in which the interleaving between sub-dialogs is represented with the aid of transitions and of transition activation by means of determined signals.

Advantageously, in a step b, a process of animating the specification thus obtained is then defined.

This process consists of dynamically exploring (computing the successions of states of) the modeled specification. It comprises activation/deactivation sequences of the transitions of the specification. It may be translated according to the following algorithmic schematic:

```
“Initialize the system // creation of the controller process
Stack the initial state of the system
Repeat
  While there are unstable states do
    If there is at least one activatable transition of an unstable state, then
    Fire at random an activatable transition of an unstable state
    Else
    Quit  End if
  End while
If at least one stable state exists, then
  compute all the transitions that can be activated from the stable states
  choose a computed transition or choose a backtrack
  If choice of a transition, then
    Stack the system state
    Fire the chosen transition
  Else
    Unstack the system state // deactivation of the transitions from
    the last stack
  End if
End if
Until there are no more active processes in the system”
```

This process of animating the specification may be applied to constitute a simulation of the specification (step c), which may be used to validate the specification relative to the operating requirements of the voice dialog. This process may also be applied to generate test cases (step d), which may be applied during the validation of an implementation of the voice dialog.

When this process is used in the context of a simulation step, the choice of the transition from a stable state is made by the user who directs the simulation.

An animation process thus defined allows the possibility of a backtrack in the animation. Since the internal transitions of the service (from an unstable state) are automatically actuated, the application of the process makes it possible to simulate the service as it is perceived by an external user.

This process of animating the specification may also be used in the context of a step for generating test cases. In this case, the choice of transitions is made by the tester device according to the desired test cases.

The backtrack and choice properties, external to the process, of the transitions that can be activated from the stable states also make it possible to use the animation process for the purposes of test generations based on standard tools (see “Test Generation with Inputs, Outputs and Quiescence,” J. Tretmans, in Second International Workshop on Tools and Algorithms for the Construction and Analysis of Systems, TACAS'96, Passau, Germany. Springer Verlag, LNCS 1055, March 1996, or T. Margaria and B. Steffen, editors, “Testing Labelled Transition Systems with Inputs and Output,” J. Tretmans, in 8th International Workshop on Protocols Test Systems, Evry—France, September 1995).

The test generation method using the specification according to the invention is divided in an implementation mode into the following three steps.

The first step consists of abstracting the combinatory behaviors of the specifications, typically the data entry functions, by generic inputs. The objective of this step is to transform potentially infinite behaviors on specification inputs into behaviors whose inputs are finite and countable.

This arrangement makes it possible to provide a solution to a major problem in the generation of test cases, relating to the selection of pertinent test inputs.

For example, in the case of an inverted directory voice service, the specification of the service describes a dialog of entering a 10-digit number, and the object of the tests on the service is to verify the response of the service according to the numbers dialed. The set of valid inputs for the entry of a number contains 10¹⁰ solutions. Naturally, it is not possible to envisage testing the service with all the solutions. In addition, the solutions are obtained according to what is expected of the service, but are not linked to the functional properties of the service. In practice, one subset of solutions corresponds to invalid inputs, another subset to inputs corresponding to professionals in the directory, another subset to inputs corresponding to individuals in the directory, etc.

The abstraction operation makes it possible to test all the functionalities of the service according to a representative of each subset.

Abstraction consists of abstracting inputs so that each abstracted input applied to one of the specification identifies a set of uniform and unique behaviors relative to other abstractions of behavior of the state.

For example, in the inverted directory service, in the number entry state, the possible abstractions are:

i. an input abstracting a sequence of DTMFs having as a functional property the representation of invalid numbers;

ii. an input abstracting a sequence of DTMFs having as a functional property the representation of numbers that exist in the directory; or

iii. an input abstracting a sequence of DTMFs having as a functional property the representation of numbers that do not exist in the directory.

The choice of abstractions must be guided by the engineer responsible for the validation according to the properties of the service that he or she desires to test.

The second phase of the test generation method consists of interfacing a test generator and a device applying the above-mentioned specification animation process. The test generator will define the observed inputs, that is, choose the transitions to which the animation process will react.

In this step of the method, it is supposed that the specification has been the subject of abstractions on all the combinatory input sequences, and that it is totally controllable, i.e., irrespective of the state of the specification, there are no two identical controllable inputs such that the activation of one or the other causes a different observable behavior (this is called a specification whose control is deterministic).

The test generation tool is like that described in “Test Generation Derived from Model-Checking”, by T. Jéron and P. Morel, in Nicolas Halbwachs and Doron Peled, editors, CAV'99, Trento, Italy, volume 1633 of LNCS, pages 108-122, Springer-Verlag, July 1999. In the test generation step, the user programs in this tool the inputs that are controllable and the outputs that are observable. In the case of voice dialogs, the controllable inputs are the abstractions defined by the validation engineer and where necessary, particular DTMF key operations and, as for the observable outputs, these are the messages produced by the service.

Finally, test cases are produced by selecting observable behaviors of the service so that each behavior has an execution trace whose first action is the initialization of the service, and whose last action is the end of the service. According to this principle, the behavior at the input of the service being finite, it is possible to produce a set of test cases comprehensively covering all the branches of the service.

The test cases produced during the test generation phase contain sequences of behaviors including the abstractions previously indicated and produced on the specification. To make these test cases executable on an implementation of a service, it is necessary, in a final step, to concretize the test cases obtained.

The concretization step consists of, on the one hand, replacing the abstracted inputs by sequences of concrete inputs (for example replacing the abstracted input representing a wrong number by a corresponding series of DTMFs), and on the other hand, translating the test into an executable language. The translation into executable language consists of making the logic inputs of the tests correspond to the physical inputs of the service. To carry out this translation, it is possible to use the TTCN3 test language that is specially dedicated to this problem.

In one embodiment of the invention, all the steps of a method are automated and applied by running a computer program.

In one embodiment, a method according to the invention is applied by a device comprising means for this application.

The invention, therefore, makes it possible to produce a specification of a voice dialog, to determine therefrom, independently of the implementation achieved, a simulation of the specified dialog and of the test cases for this dialog while solving the problem of combinatory explosion habitually encountered in such test cases.

1. A method of creating a voice dialog for a communication system, comprising:
defining a plurality of sub-dialogs;
determining a plurality of chaining sequences between at least two of said plurality of sub-dialogs; and
producing a specification of the voice dialog by transforming at least one of said plurality of sub-dialogs and at least one of said plurality of chaining sequences into elements of a low-level formal model.

2. A method according to claim 1, wherein said voice dialog is created for simulating interactions between a voice application and a user terminal, further comprising the following steps:
defining said plurality of sub-dialogs in a predetermined voice dialog.

3. A method according to claim 2, wherein said low-level formal model is an input/output labeled transition system model.

4. A method according to claim 3, wherein said plurality of chaining sequences are defined according to at least one of a plurality of rules, said plurality of rules comprising call rules, continuation rules, and termination rules.

5. A method according to claim 4, wherein said plurality of rules relate to sub-dialogs included in the dialog according to at least one of a plurality of transitions of said transition system model and to the activation of said at least one of a plurality of transitions.

6. A method according to claim 3, further comprising the following step:
applying an algorithmic process of animating the specification.

7. A method according to claim 6, wherein said applying step further comprises the following steps:
activating at least one of said plurality of transitions; and
deactivating at least one of said plurality of transitions.

8. A method according to claim 7, wherein said applying step comprises of successive steps of said activating step and said deactivating step.

9. A method according to claim 8, wherein said applying step produces at least one step of validating the simulated dialog defined by the specification.

10. A method according to claim 9, wherein said applying step further produces at least one step of generating validation test cases designed to test an implementation of the dialog.

11. A method according to claim 10, wherein said step of generating validation test cases comprises:
modifying the specification by replacing a plurality of inputs with a single abstracted input, the algorithmic process of animating the specification being applied to the specification thus modified.

12. A voice dialog creation device for a communication system, comprising:
means for defining a plurality of sub-dialogs;
means for determining a plurality of chaining sequences between at least two of said plurality of sub-dialogs; and
means for producing a specification of the voice dialog by transforming at least one of said plurality of sub-dialogs and at least one of said plurality of chaining sequences into elements of a low-level formal model.

13. A device according to claim 12, wherein said voice dialog is created for simulating interactions between a voice application and a user terminal, further comprising:
means for defining said plurality of sub-dialogs in a predetermined voice dialog.

14. A device according to claim 13, wherein said low-level formal model is an input/output labeled transition system model.

15. A device according to claim 14, wherein said plurality of chaining sequences are defined according to at least one of a plurality of rules, said plurality of rules comprising call rules, continuation rules, and termination rules.

16. A device according to claim 15, wherein said plurality of rules relate to sub-dialogs included in the dialog according to at least one of a plurality of transitions of said transition system model and to the activation of said at least one of a plurality of transitions.

17. A device according to claim 14, further comprising:
means for applying an algorithmic process of animating the specification.

18. A device according to claim 17, wherein said applying means further comprises:
means for activating at least one of said plurality of transitions; and
means for deactivating at least one of said plurality of transitions.

19. A device according to claim 18, wherein said applying means comprises of successive applications of said activating means and said deactivating means.

20. A device according to claim 19, wherein said applying means comprises:
means for validating the simulated dialog defined by the specification.

21. A device according to claim 20, wherein said applying means further comprises:
means for generating validation test cases designed to test an implementation of the dialog.

22. A device according to claim 21, wherein said means for generating validation test cases comprises:
means for modifying the specification by replacing a plurality of inputs with a single abstracted input, the algorithmic process of animating the specification being applied to the specification thus modified.

23. A computer program stored on a computer-readable medium, comprising the instructions of:
defining a plurality of sub-dialogs;
determining a plurality of chaining sequences between at least two of said plurality of sub-dialogs; and
producing a specification of the voice dialog by transforming at least one of said plurality of sub-dialogs and at least one of said plurality of chaining sequences into elements of a low-level formal model.

24. A computer program according to claim 23, wherein said voice dialog is created for simulating interactions between a voice application and a user terminal, further comprising the following instruction:
defining said plurality of sub-dialogs in a predetermined voice dialog.
